(19) United States
(12) Patent Application Publication
(10) Pub. No.: US 2007/0296330 A1
(43) Pub. Date: Dec. 27, 2007

(54) Module composed of two light sources and generating tri-band white light with adjustable chromaticity diagram

(76) Inventor: Joe Yang, Taichung City (TW)

Correspondence Address: CHARLES E. BAXLEY, ESQ., 90 JOHN STREET, THIRD FLOOR, NEW YORK, NY, 10038, US

(21) Appl. No.: 11/729,238

(22) Filed: Mar. 27, 2007

(30) Foreign Application Priority Data
Mar. 28, 2006 (TW) 095110808

(51) Int. Cl. H01J 1/62

(52) U.S. Cl. 313/504

(57) ABSTRACT

The present invention relates to an improved structure of producing white light for LED, and the structure is a light emitting element composed of two chips of different color lights. The two chips are bonded with each other in series. In an epitaxial formation and manufacturing process, a first metal contact end is formed on the backside of the chip in the front and a second metal contact end is formed on the front side of the chip at the back, and the interfaces of the first and second contact ends are bonded by an eutectic solder, so that the two chips are electrically and mechanically coupled with each other. The invention simply uses a current to drive two chips to produce white light, and thus effectively saving the space of a printed circuit board, and enhancing the performance of the LED semiconductor manufacturing process.

### FIELD OF THE INVENTION

The present invention relates to a module composed of two light sources and generating tri-band white light with adjustable chromaticity diagram, and more particularly relates to a unique design of having two light sources to mix and generate tri-band white light and effectively enhance the light mixing effect, thereby further lower its production cost and make it more convenient to adjust its chromaticity.

### BACKGROUND OF THE INVENTION

Generally, an LED (Light Emitting Diode) has following features: (1) High luminescence efficiency; (2) high response rate; (3) conserves power; (4) wide scope of usable temperature; and (5) long longevity. Its theory of luminescence is by utilizing semiconductor's hopping transport feature to emit corresponding wavelength light with material energy gap or quantum well energy level; presently, its luminescence component comprises different wavelength colors including red light spectrum, blue light spectrum, green light spectrum and yellow light spectrum. The white light LED is formed by at least more than two color spectra and can be used to replace the conventional incandescent lamps that are of low efficiency, high energy consumption, short longevity and easily breakable.

The present manufacturing technology of a white light LED comprises: (1) Formed by InGaN blue light LED coupled with the yellow light YtAl garnet phosphor powder; (2) use a plurality of LEDs consisting of the red AlInGaP material, the green AlInGaN material and the blue AlInGaN material to form the white light source; (3) use the UV LED coupled with the red, green and blue phosphor powder; (4) employ the technology of using the ZnSe material system to generate white light; and (5) employ the theory of mixing blue and yellow light to form white light, that is using the blue and yellow luminescent components to generate white light;

The different technologies for generation of white light have advantages and disadvantages, for instance, the first technology mentioned above lacks the red composition, thereby its color display is not so good and could also result in color shift with increase in electric current; the second technology requires a plurality of circuits, making it complicated to control and expensive to produce; the efficiency of phosphor powder used in the third technology is low and easily degenerate due to UV exposure because of poor packaging materials; the fourth technology is of no practical use because of low luminescence efficiency and short longevity; and the narrow light spectrum used in the fifth technology made it difficult to produce the optimum white light.

One of the luminous components emits visible blue color light in blue color spectrum (with only the blue color element) whose wavelength is 450 nm˜470 nm; another luminous component emits visible yellowish green color light in yellowish green color spectrum (with only the yellow and the green elements) whose wavelength is 565 nm˜580 nm. Since the brightness of the yellowish green luminous component is low, therefore, the brightness of the product of mixed lights is also low and cannot be mixed into warm white light (2000K˜4000K) (per published patent No. 570313).

Furthermore, as illustrated in FIG. 7, an LED module mentioned above using tri-color RGB light sources to blend into white light requires 3-axis for color adjustment. This way, not only more control circuits are needed and made the structure more complicated, as well as raising its production cost, and made chromaticity adjustment more complicated since 3-axis is involved in modifications. As regards the use of LED module to blend white light with two light sources, the blending effect is not satisfactory.

As explained above, to use an LED as a white light source, it must have fine chromaticity, luminous efficiency, simplified structure and low production cost to be extensively accepted and employed. The present invention provides a module composed of two light sources and generating tri-band white light with adjustable chromaticity diagram and thereby meets aforementioned conditions.

Henceforth, the primary objective of the present invention is to provide a module composed of two light sources and generating tri-band white light with adjustable chromaticity diagram that can lower production cost and generate tri-band white light source.

### SUMMARY OF THE INVENTION

The present invention relates to using a module composed of two light sources and generating tri-band white light with adjustable chromaticity diagram, and more particularly relates to a low priced module with easy chromaticity adjustment. The present invention comprises two light sources with luminous layers of multi-layer epitaxy structure, and among them include a light source of bluish green light spectrum with a wavelength of 465 nm˜495 nm, and another light source of yellowish orange light spectrum with a wavelength of 580 nm˜605 nm. Both light sources are to be set on the same substrate and the distance between the two light sources should not exceed the light mixing scope; further, the two light sources emit visible mixed white light and further generate close to tri-band white light's intensity and color tone, enhance the light mixing effect of the white light, as well as lowering production cost and even be made more convenient for adjusting its chromaticity.

### BRIEF DESCRIPTION OF THE DRAWINGS

FIG. 1 is a schematic view of the first preferred embodiment of the present invention using a module composed of two light sources and generating tri-band white light with adjustable chromaticity diagram;

FIG. 2 is a schematic view of the second preferred embodiment of the present invention using a module composed of two light sources and generating tri-band white light with adjustable chromaticity diagram;

FIG. 3 is a schematic view of the third preferred embodiment of the present invention using a module composed of two light sources and generating tri-band white light with adjustable chromaticity diagram;

FIG. 4 is a schematic view of the fourth preferred embodiment of the present invention using a module composed of two light sources and generating tri-band white light with adjustable chromaticity diagram;

FIG. 5 is a schematic view of the fifth preferred embodiment of the present invention using a module composed of two light sources and generating tri-band white light with adjustable chromaticity diagram;

FIG. 6 is a schematic view of the sixth preferred embodiment of the present invention using a module composed of two light sources and generating tri-band white light with adjustable chromaticity diagram;

FIG. 7 is a light spectrum diagram of an LED illustrating the adjustable chromaticity diagram in accordance with the present invention.

### DETAILED DESCRIPTION OF THE PREFERRED EMBODIMENT

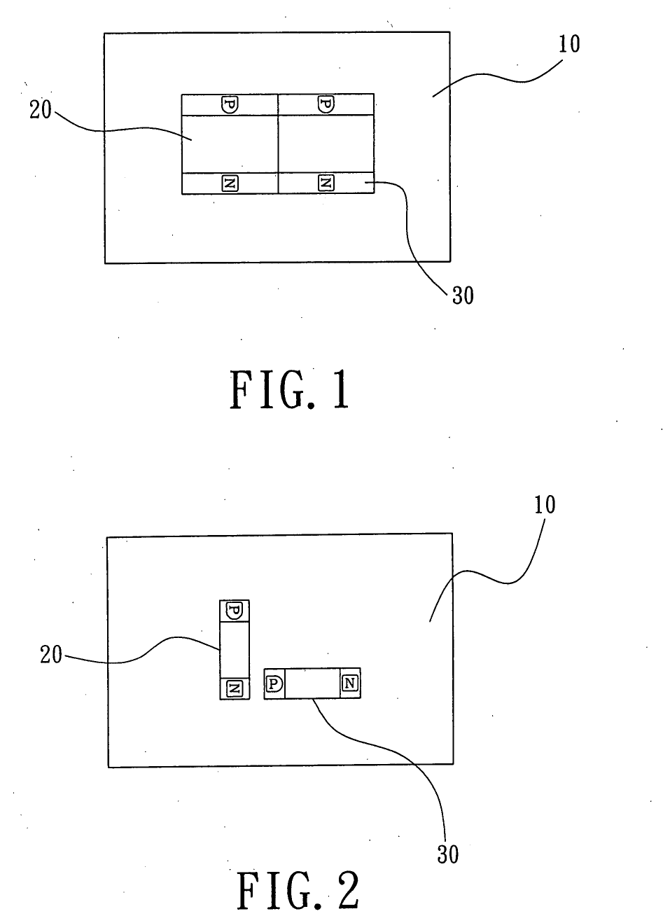

The present invention relates to a module composed of two light sources and generating tri-band white light with adjustable chromaticity diagram; referring to FIG. 1, the invention comprises a substrate 10 and two light sources 20 and 30:

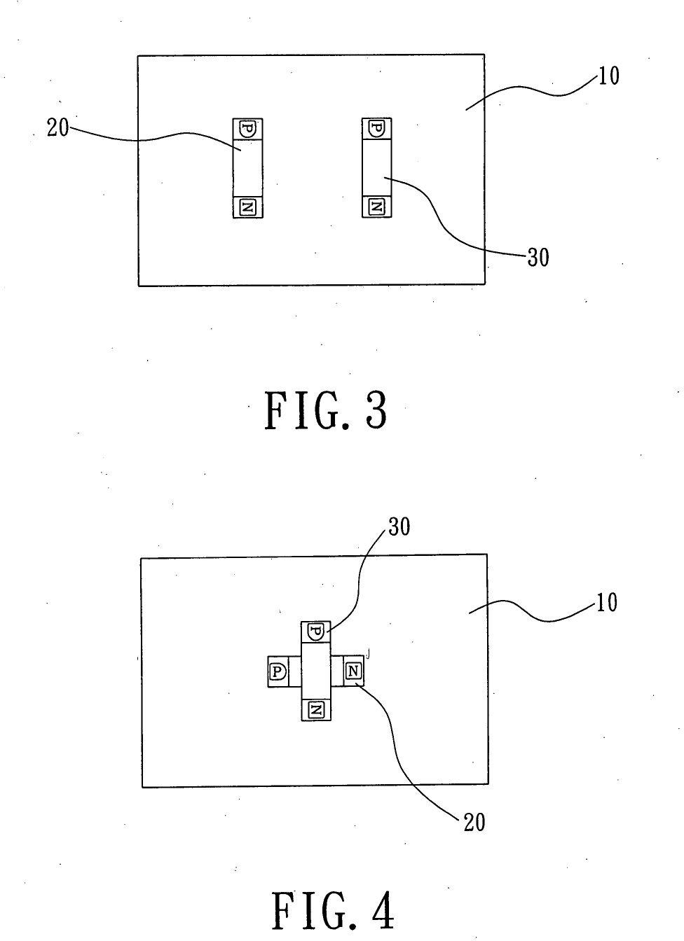

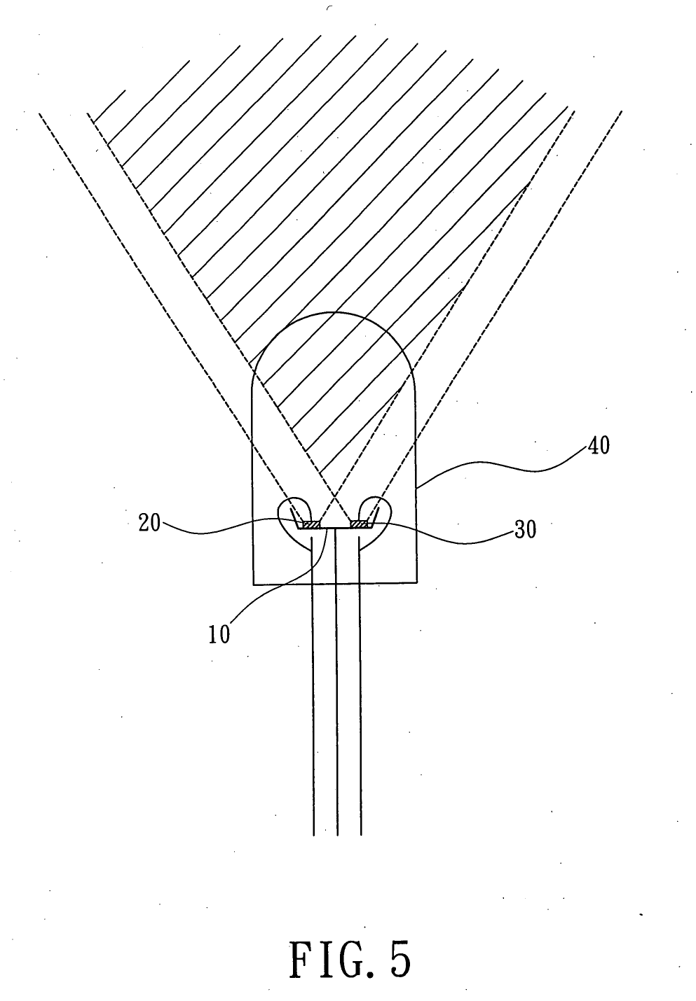

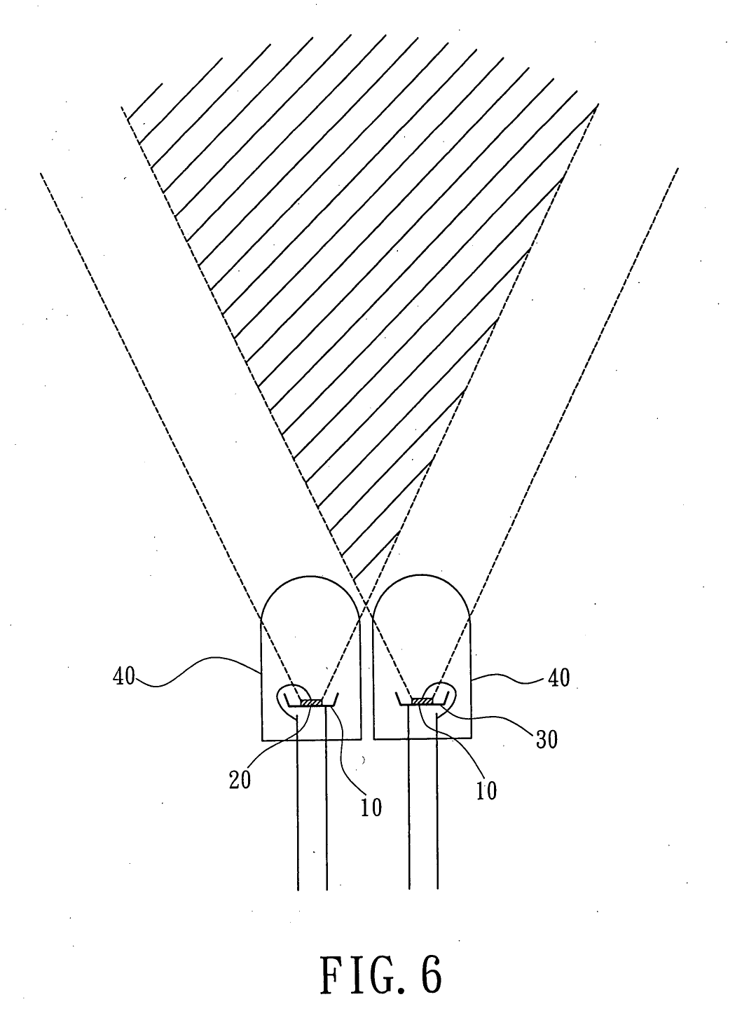

For detail construction of the present invention, refer to FIGS. 1˜4 which disclose that two light sources 20 and 30 are being set on one substrate 10. The two light sources 20 and 30 can be unpackaged LED chips being disposed on the substrate 10 either in adjacent disposition (as shown in FIG. 1), vertical disposition (as shown in FIG. 2), facing disposition (as shown in FIG. 3), or stacking disposition (as shown in FIG. 4); the two light sources 20 and 30 can also be separately packaged LED chips 40 being disposed adjacent to each other (as shown in FIG. 5), or one packaged LED 40 being jointly disposed (as shown in FIG. 6); the distance between the two light sources 20 and 30 must not exceed the light mixing scope, and the substrate 10 can either be a circuit board, a silicon board, or an FC (flip chip) substrate which permits electric conduction for the two light sources 20 and 30;

The two light sources 20 and 30 have respectively luminous layers of multi-layer epitaxy structure, where one light source 20 is in bluish green light spectrum (comprising a blue element and a green element) and emits visible bluish green light with a wavelength of 465 nm˜495 nm (although wavelength 465 nm˜480 nm is in light blue color, the visible light still has the green element and looks bluish green). Another light source 30 is in yellowish orange spectrum (comprising a red element and a yellow element) and emits visible yellowish orange color light with a wavelength of 580 nm˜605 nm;

Henceforth, upon activating the two light sources 20 and 30 in bluish green and yellowish orange light spectra on the substrate 10, the RGB tri-color elements of blue color, green color and red color produce tri-band white light source and form a simple structure, low cost module composed of two light sources and generating tri-band white light with adjustable chromaticity diagram.

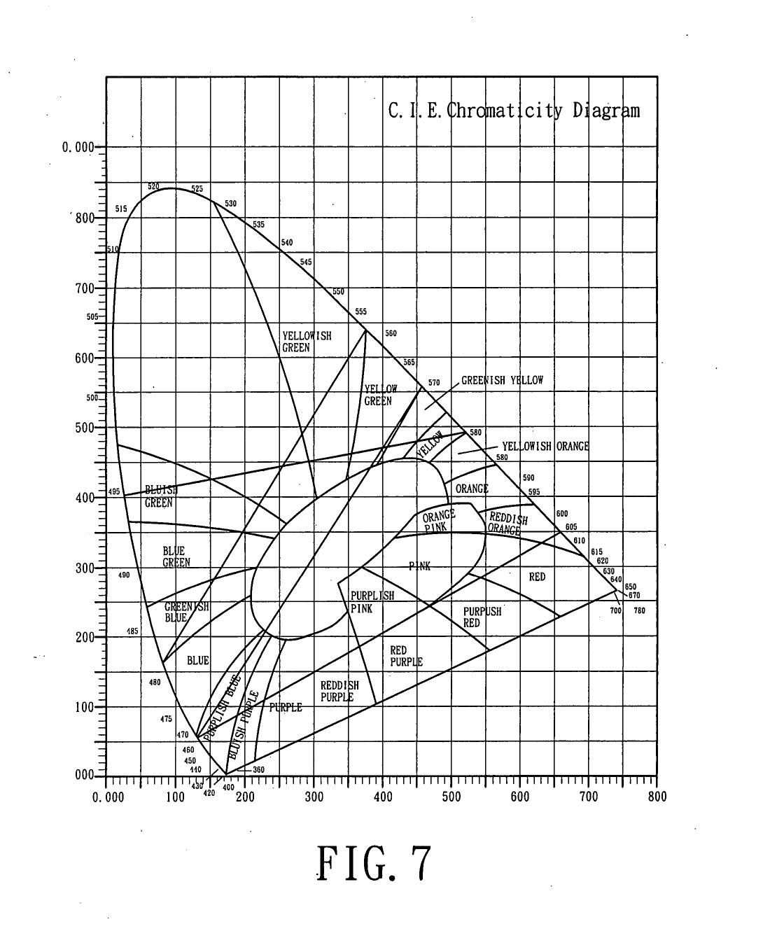

Referring to the design described above, and coupled with FIG. 7, the adjustable scope of conventional light mixing (for instance per U.S. Pat. No. 570,313) as viewed from CIE Chromaticity Diagram is comparatively small and cannot produce warm white light; the module of the present invention, however, has a wider chromaticity adjustable scope to cover the entire white light scope, and can therefore produce warm white light. Furthermore, since the present invention uses only two light sources 20 and 30 to generate tri-band white light, only 2-axis is required for adjusting its chromaticity, thereby drastically simplify circuit control and the complexities of adjustment. Compared to the conventional tri-color light mixer, the module is of low production cost and easy to adjust chromaticity.

What is claimed is:

1. A module composed of two light sources and generating tri-band white light with adjustable chromaticity diagram, comprising a substrate and two light sources:
the two light sources are jointly set on a substrate, and the two light sources have respectively luminous layers of multi-layer epitaxy structure; one of the light source is in bluish green light spectrum and emits visible bluish green light with a wavelength of 465 nm˜495 nm, and another light source in yellowish orange light spectrum with visible yellowish orange light with a wavelength of 580 nm˜605 nm;
thus, tri-band white light source is produced and a simple structure and low cost module is capable of enhancing luminous efficiency and utilizing the two light sources to generate tri-band white light with adjustable chromaticity diagram.

2. The module composed of two light sources and generating tri-band white light with adjustable chromaticity diagram as recited in claim 1, wherein the two light sources are set on the substrate in adjacent disposition.

3. The module composed of two light sources and generating tri-band white light with adjustable chromaticity diagram as recited in claim 1, wherein the two light sources on the substrate can be in vertical disposition.

4. The module composed of two light sources and generating tri-band white light with adjustable chromaticity diagram as recited in claim 1, wherein the two light sources on the substrate can be in a facing disposition at a certain distance but the distance must not exceed the light mixing scope.

5. The module composed of two light sources and generating tri-band white light with adjustable chromaticity diagram as recited in claim 1, wherein the two light sources are set on the substrate in stacking disposition.

6. The module composed of two light sources and generating tri-band white light with adjustable chromaticity diagram as recited in claim 1, wherein the substrate is a circuit board.

7. The module composed of two light sources and generating tri-band white light with adjustable chromaticity diagram as recited in claim 1, wherein the substrate is a silicon board.

8. The module composed of two light sources and generating tri-band white light with adjustable chromaticity diagram as recited in claim 1, wherein the substrate is an FC (flip chip) board.

9. The module composed of two light sources and generating tri-band white light with adjustable chromaticity diagram as recited in claim 1, wherein the light source is an unpackaged LED chip.

10. The module composed of two light sources and generating tri-band white light with adjustable chromaticity diagram as recited in claim 1, wherein the light source is a packaged LED.
